(19) United States
(12) Patent Application Publication
(10) Pub. No.: US 2006/0227804 A1
(43) Pub. Date: Oct. 12, 2006

(54) Method for enablement for offloading functions in a single LAN adapter

(75) Inventors: Ron Encarnacion Gonzalez, Austin, TX (US); Binh K. Hua, Austin, TX (US); Sivarama K. Kodukula, Round Rock, TX (US); Rakesh Sharma, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/101,616

(22) Filed: Apr. 7, 2005

(51) Int. Cl. H04L 12/66

(52) U.S. Cl. 370/463

(57) ABSTRACT

A method, apparatus and computer program product are provided for offloading functions to improve processor performance. A single LAN adapter is provided that allows for predefined functions to be offloaded to other devices. Different methods are described for offloading functions. First, users and applications may pick and choose, on demand, only the functions that are to be offloaded. Second, a scheduler schedules those functions that are to be offloaded through a predetermined scheduler. Third, functions may be offloaded based on heuristic or learning methods which are stored in a knowledge database.

### BACKGROUND OF THE INVENTION

1. Technical Field

The present invention relates generally to offloading functions to improve processor performance. Still more particularly, the present invention offloads functions in a single LAN adapter in order to improve processor performance.

2. Description of Related Art

In the relatively short time since computers were first connected together, Local area network (LAN) technologies and performance have improved substantially. The earliest Ethernet networks were constructed from a single length of coaxial cable that was tapped once for each network device. This style of interconnection appeared in the early 1980s, when computer networking was accomplished with Thicknet (known now as 10BASE-5) and later using IEEE 802.3 standards. The mechanical process of interconnecting computers improved slightly with the adoption of Thinnet (known now as 10BASE-2) which eliminated the need to tap cable. Although interconnecting devices was much easier with Thinnet's coaxial connectors, this technology continued to string network devices together on a single length of coaxial cable. Layer 2 packets transmitted between devices utilizing either of these standards are received by all other devices on the cable. The group of devices (also called a segment) which can receive transmissions from all other connected devices is called a collision domain. A packet transmission protocol, CSMA/CD for these standards, was necessary to control the orderly transmission of information over a single collision domain. In this overview, the group of devices (segment) which can receive a Layer 2 broadcast is referred to as a broadcast domain. Additionally, the group of devices (segment) that can receive unicast Layer 2 packets not directly addressed to the device is referred to as a repeated segment.

Over time the single wire implementations were replaced by Ethernet repeated segment HUBs and RJ-45 style cabling (10BASE-T). The change to modular 10BASE-T components provided a huge improvement in the methods used to interconnect LAN devices, but the performance limitations of single broadcast domains and CSMA/CD remained. Local area networks grew to port densities where hundreds of computers would be sharing the same 10Mb broadcast domain. LAN administrators quickly discovered that large broadcast domains were inconsistent with network performance and data privacy.

Layer 2 Ethernet bridges and Ethernet switches do not forward unicast packets out a port unless the destination device is located behind the port. Because of this feature, bridging and switching were two of the first methods used to limit the size of collision domains and repeated LAN segments. The deployment of switches and bridges brought increases in LAN performance and data privacy. As the price of Layer 2 switching technology decreased and port densities on these switches increased, LAN administrators started to deploy switches to the very edge of the network. Although repeated hubs can still be found in smaller networks and SOHO applications, Ethernet switches have almost entirely replaced repeated hub devices in modern LANs.

Over the past 10 years, LAN technology, Ethernet in particular, has improved the media speed tenfold every 3 to 4 years. By contrast, the central processing unit (CPU) speed doubles every other year. Consequently, the CPUs are becoming the bottleneck at a rapid rate in high I/O performance systems. To alleviate this lag in processor performance, an increasing number of native host functions can be offloaded to I/O adapters. Offloading functions reduces the host CPU workload and has the added benefit of improving the I/O adapter throughput. However, care must be exercised in selecting the functions to be offloaded because customers require different sets of offload functions depending on applications. Currently, I/O adapter vendors attempt to address these customer needs by customizing their I/O solutions with specific offload functions they feel customers would want. This “hit and miss” approach turns out to be an expensive proposition due to the cost of testing and maintaining several versions of adapters. Even with multi-level offload functions (more than one) for the same type of adapter, the solution is far from perfect.

Another problem with using the current approach is that the same offload function occurs when all of the applications use the same adapter. This creates a problem because some applications may not need or do not perform well with the offloaded functions. For example, in a TCP/IP environment, applications that send and receive only small packet sizes may not perform well with the offloaded checksum function because the process to prepare offloads may be more CPU intensive than simply calculating the checksum.

Thus, it would be advantageous to have a single LAN adapter that would provide for offloading of functions to other connected devices.

### SUMMARY OF THE INVENTION

The present invention provides a method, apparatus and computer program product for offloading functions to improve processor performance. The exemplary aspect of the present invention provides a single LAN adapter that allows for predefined functions to be offloaded to other devices. Three ways of offloading functions are provided. First, is for users and applications to pick and choose, on demand, only the functions that are to be offloaded. Second, is for the scheduling of functions to be offloaded through a predetermined scheduler. Third, is for a heuristic or learning of those functions that can be offloaded through a knowledge database.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system that may be implemented as a server in accordance with a preferred embodiment of the present invention;

FIG. 3 is an illustration of two adapters residing in the same system in accordance with a preferred embodiment of the present invention;

FIG. 4 a functional block diagram of the operating system is depicted in accordance with a preferred embodiment of the present invention;

FIG. 5 depicts an exemplary on-demand interface in accordance with a preferred embodiment of the present invention;

FIG. 6 illustrates an exemplary schedule driven interface in accordance with a preferred embodiment of the present invention;

FIG. 7 illustrates an exemplary heuristic or learning interface in accordance with a preferred embodiment of the present invention;

FIG. 8 illustrates an exemplary table of events in accordance with a preferred embodiment of the present invention; and

FIG. 9 illustrates a flow diagram of an exemplary operation of offloading functions in accordance with a preferred embodiment of the present invention.

### DETAILED DESCRIPTION OF THE PREFERRED EMBODIMENT

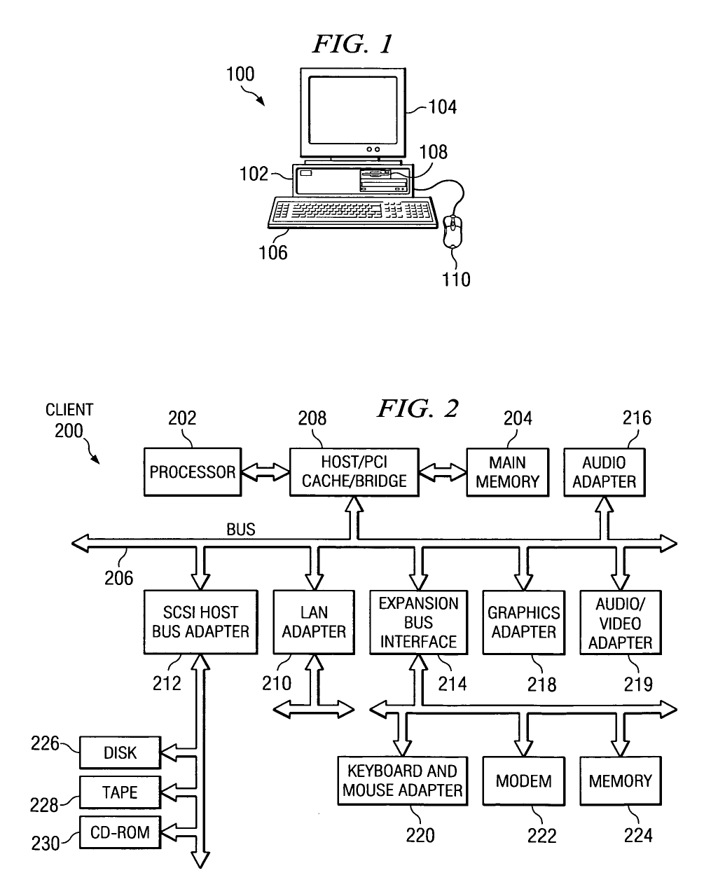

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 200. “JAVA” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides for offloading functions to improve processor performance. A single LAN adapter is described that allows for predefined functions to be offloaded to other devices. Three different means are described through which functions may be defined for offloading. First, a user or application may pick and choose, on demand, only the functions that are to be offloaded. Second, scheduling of those functions to be offloaded may defined in a scheduler. Third, heuristic or learning capabilities are provided where an offloading of functions may be stored in a knowledge database.

The exemplary aspects of the present invention are best described using an example. The present invention uses a TCP/IP protocol function for illustration purposes only. This exemplary description does not limit the scope of this invention as any function may be offloaded using the features described.

In this example, all I/O adapters have offload functions enabled as a default. A combination of IP address, TCP socket port number, and an access control key are used to control the type of offload function that is made available to users and/or applications. Therefore, two different users and/or applications may share the same IP address to communicate to a network, but may not have the same offload functions available. Access to offload functions for a particular socket port number may be controlled via special keys issued to users and/or applications. This key is then used by TCP/IP stacks to identify which offload functions are allowed for each socket port. Some well known applications, such as, “FTP” can be pre-enabled to certain default offload functions.

This type of offloading would improve processor performance and improve I/O adapter performance. Using this approach saves I/O adapter suppliers time and money by simplifying their supply chain because they only need to release a single part number with a super set of offload functions. End users also save money because they only need to activate and pay for the function(s) they need. This solution saves suppliers money and meet customers' needs by providing them with the flexibility afforded by on-demand offload functions.

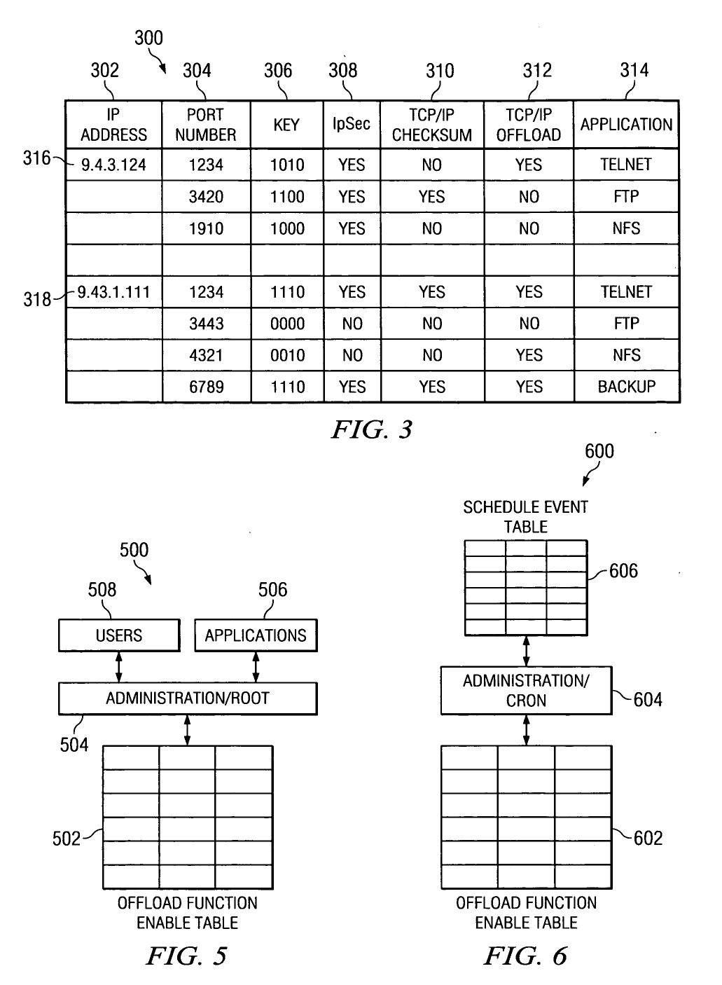

Turning now to FIG. 3, a further illustration of two adapters residing in the same system is depicted in a table in accordance with a preferred embodiment of the present invention. In exemplary table 300 in FIG. 3, IP address 302, port number 304, key 306, IPsec 308, TCP/IP checksum 310, TCP/IP offload 312 and application 314 are provided for each IP address; however, other items may also be included in this table. In this table, two IP addresses, or adapters, 316 and 318 reside in the same system. IP address 316, has the IPsec, TCP/IP checksum, and TCP/IP offload functions defined. However, the Telnet, FTP, and NFS applications, associated with IP address 316, have different offload default functions enabled, all controlled via their respective port numbers. For IP address 318, the system can have all offload functions for Telnet and backup applications enabled as a default. The current settings of IP addresses 316 and 318 are summarized in FIG. 3. Although FIG. 3 describes a table any other type of data structure may be used, such as an array, a hash, a scalar, ect.

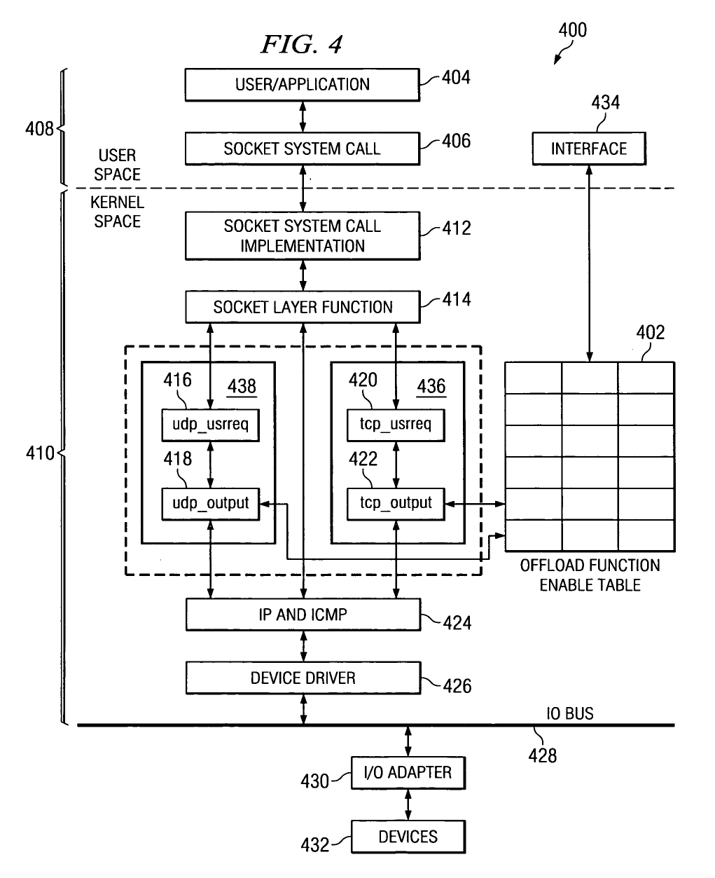

Turning now to FIG. 4, a functional block diagram of the operating system maintaining table 300 shown in FIG. 3 is depicted in accordance with a preferred embodiment of the present invention. Exemplary operating system 400 has the task of maintaining offload function enable table 402 which is similar to table 300 in FIG. 3. In this example, user or application 404 initiates a socket system call 406 from user space 408 to kernel space 410. In kernel space 410, socket system call implementation 412 receives socket system call 406, parses this call and initiates any embedded socket layer function 414.

Socket layer function 414 determines the type of function that is requested and sends the function at the appropriate protocol. Offload function enable table 402 is initialized by an operating system during initial program load (IPL). Offload function enable table 402 is either manually or automatically updated via interface 434 by either adding or deleting offload functions on the system during run time. The examples of interface 434 are described later with respect to FIGS. 5, 6, and 7 below. Any of the protocols that exist in the operating system may query offload function enable table 402.

The operating system enforces access controls on the offload hardware by enabling offload attributes on per-TCP connection basis. When offload capability is set in offload function enable table 402, connection is offloaded to I/O adapter 430, otherwise standard Ethernet NIC interface is used. This methodology enables use of offload on a per TCP connection basis which is associated with a particular system user and/or application. Furthermore, it makes offload usage accounting on with a system user and/or application.

Further, socket layer function 414 sends user datagram protocol (UDP) packets to upd_usrreq 416 which is converted and sent out of udp_output 418. However, the UDP function call would be sent over the standard Ethernet NIC interface since the UDP function is not listed in the offload function enable table 402. Socket layer function 414 also sends transmission control protocol (TCP) packets to tcp_usrreq 420 which is converted and sent out of tcp_output 422. Then, tcp_output 422 which is part of TCP/IP stack 436 queries the data on offload function enable table 402 and interfaces the call to device driver 426 for the selected offload functions.

Socket layer function 414 also sends transmission control protocol (UDP) packets to udp_usrreq 416 which is converted and sent out of udp_output 418. Then, udp_output 418 which is part of UDP/IP stack 438 queries the data on offload function enable table 402 and interfaces the call to device driver 426 for the selected offload functions.

Socket layer function 414 also sends internet protocol (IP) and internet control message protocol (ICMP) packets directly to internet protocol (IP) and internet control message protocol (ICMP) queue 424. However, the IP/ICMP function call would be sent over the standard Ethernet NIC interface.

Turning to FIG. 5, an exemplary on-demand interface is depicted in accordance with a preferred embodiment of the present invention. On-demand interface 500 is an example of interface 434 in FIG. 4 and is composed of an administrative or root interface 504 that allows users 508 and applications 506 to pick and choose, on demand, only the functions that are desired. These functions are added or deleted to offload function enable table 502 which is similar to offload function enable table 402 in FIG. 4.

FIG. 6 illustrates an exemplary schedule driven interface in accordance with a preferred embodiment of the present invention. Schedule driven interface 600 is an example of interface 434 in FIG. 4 and is composed of an administrative or CRON interface 604 that allows for enabling and disabling of unique offload features selectively for a given workload environment by a predetermined scheduler based on events listed in schedule event table 606. Workloads such as transaction processing may require certain offload functions like IPsec, SSL etc. But the same workload may not be benefited much from TCP/IP checksum offload due to the small packets. For applications involving large packet transfers such as back-up and FTP, offload features such as TCP/IP checksum, TCP/IP offload, etc. are beneficial. These workloads may vary in a day. For example, the transaction oriented network traffic may be at its peak during the day, while back-up traffic is during the night hours.

These offload features may be enabled or disabled via a predetermined scheduler based on events listed in schedule event table 606. Administrative or CRON interface 604 may be any type of scheduler such as a batch, CRON or a script. These functions are added or deleted to offload function enable table 602 which is similar to offload function enable table 402 in FIG. 4.

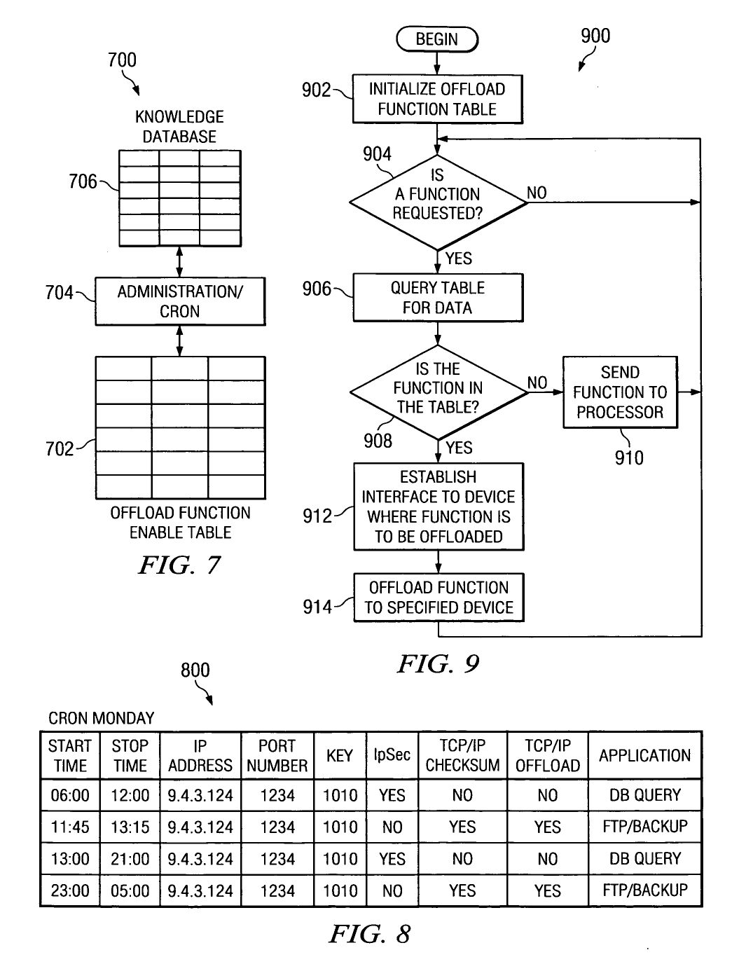

FIG. 7 illustrates an exemplary heuristic or learning interface in accordance with a preferred embodiment of the present invention. Heuristic interface 700 is an example of interface 434 in FIG. 4 and is composed of an administrative or CRON interface 704 that allows for enabling and disabling of unique offload features selectively for a given workload environment by learned events that are stored in knowledge database 706.

In most of the network installations, although the workloads are predetermined, they may vary due to the changing demands or seasonal variation. These changes can be monitored, analyzed and posted in knowledge database 706. Several tools exist to analyze the data from the database and characterize the application workload with respect to time of day. Workloads such as transaction processing may require certain offload functions like IPsec, SSL, etc. But the same work load may not be benefited much from TCP/IP checksum offload due to the small packets. For applications involving large packet transfers such as back-up and FTP, offload features such as TCP/IP checksum, TCP/IP offload etc are beneficial.

These offload features may be enabled or disabled via heuristic scheduler based on events listed in knowledge database 706. Administrative or CRON interface 704 may be any type of scheduler such as a batch, CRON or a script. These functions are added or deleted to offload function enable table 702 which is similar to offload function enable table 402 in FIG. 4.

FIG. 8 illustrates an exemplary table of events in accordance with a preferred embodiment of the present invention. Table 800 is an example of schedule event table 606 in FIG. 6 or knowledge database 706 in FIG. 7. In table 800 CRON event entries for two consecutive Mondays; however, other items may also be included in this table. As shown, these entries are not identical for both Mondays. The reason may be one of the days is a holiday (Sept 6th, Labor Day) or a seasonal change. So the offload parameters are optimized for backup jobs for the second Monday. Although FIG. 8 describes a table any other type of data structure may be used, such as an array, a hash, a scalar, ect.

In FIG. 9, flow diagram 900 illustrates an exemplary operation of offloading functions in accordance with a preferred embodiment of the present invention. As this exemplary operation begins, the operating system initializes the offload function table (step 902). The system then determines if a function has been requested (step 904). If no function has been requested, then the system returns to step 904 until a function is requested. If a function is requested, then a query of the offload function table is performed to determine if the function should be offloaded (step 906). If the function is not listed in the offload function table (step 908), then the request is sent over the standard Ethernet NIC interface to be processed (step 910). If the function is listed in the offload function table (step 908), then an interface is established to the device where the function is to be offloaded (step 912) and the function is offloaded to the specified device (step 914).

Thus, the present invention provides a method, apparatus and computer instructions for offloading functions to improve processor performance. A single LAN adapter is provided that allows for predefined functions to be offloaded to other devices. The methods described allows for functions to be offloaded in three different ways. First, a user or application may pick and choose, on demand, only the functions that are to be offloaded. Second, scheduling of those functions to be offloaded may defined in a scheduler. Third, heuristic or learning capabilities are provided where an offloading of functions may be stored in a knowledge database.

This type of offloading would improve processor performance and improve I/O adapter performance. Using this approach saves I/O adapter suppliers time and money by simplifying their supply chain because they only need to release a single part number with a super set of offload functions. End users also save money because they only need to activate and pay for the function(s) they need. This solution saves suppliers money and meet customers' needs by providing them with the flexibility afforded by on-demand offload functions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for offloading functions, the method comprising:
receiving at a processor a request for a function to be implemented in the data processing system;
determining whether to offload the function to a network adapter based on a data structure;
responsive to a determination that the function is to be offloaded to the network adapter, establishing an interface to the network adapter and offloading the function to the network adapter; and
responsive to a determination that the function is not to be offloaded to the network adapter, processing the function using the processor.

2. The method of claim 1, wherein offloading the function to the network adapter comprises:
enforcing access controls on network adapter; and
enabling offload attributes on a per-connection basis.

3. The method of claim 1, wherein the data structure is an offload function data structure.

4. The method of claim 1, wherein the data structure is updated by a user defining the functions, which are to be offloaded.

5. The method of claim 1, wherein the data structure is updated by an application defining the functions, which are to be offloaded.

6. The method of claim 1, wherein the data structure is updated by a scheduler defining times in which functions are to be offloaded.

7. The method of claim 6, wherein the scheduler determines the times based on a scheduled event data structure.

8. The method of claim 1, wherein the data structure is updated by a heuristic interface defining events in which functions are to be offloaded.

9. The method of claim 8, wherein the heuristics interface determines the times based on stored events in a knowledge database.

10. A data processing system comprising:
a bus system;
a communications unit connected to the bus system;
a memory connected to the bus system, wherein the memory includes a set of instructions;
a network adapter; and
a processing unit connected to the bus system, wherein the processing unit executes the set of instructions to receive at a processor a request for a function to be implemented in the data processing system; determine whether to offload the function to the network adapter based on a data structure; establish an interface to the network adapter and offload the function to the network adapter in response to a determination that the function is to be offloaded to the network adapter; and process the function using the processing unit in response to a determination that the function is not to be offloaded to the network adapter.

11. The data processing system of claim 10, wherein in executing the set of instructions to offload the function to the network adapter, the processor executes a set of instructions to enforce access controls on the network adapter and enable offload attributes on a per-connection basis.

12. The data processing system of claim 10, wherein the data structure is an offload function data structure.

13. The data processing system of claim 10, wherein the data structure is updated by a user defining the functions, which are to be offloaded.

14. The data processing system of claim 10, wherein the data structure is updated by an application defining the functions, which are to be offloaded.

15. The data processing system of claim 10, wherein the data structure is updated by a scheduler defining times in which functions are to be offloaded.

16. The data processing system of claim 15, wherein the scheduler determines the times based on a scheduled event data structure.

17. The data processing system of claim 10, wherein the data structure is updated by a heuristic interface defining events in which functions are to be offloaded.

18. The data processing system of claim 17, wherein the heuristics interface determines the times based on stored events in a knowledge database.

19. A computer program product for offloading functions, the computer program product comprising:
first instructions for receiving at a processor a request for a function to be implemented in the data processing system;
second instructions for determining whether to offload the function to a network adapter based on a data structure;
third instructions for responsive to a determination that the function is to be offloaded to the network adapter, establishing an interface to the network adapter and offloading the function to the network adapter; and
fourth instructions for responsive to a determination that the function is not to be offloaded to the network adapter, processing the function using the processor.

20. The computer program product of claim 19, wherein the third instructions includes offloading the function to the network adapter comprises:
first sub-instructions for enforcing access controls on the network adapter; and
second sub-instructions for enabling offload attributes on a per-connection basis.
